(19) United States
(12) Patent Application Publication
(10) Pub. No.: US 2026/0148639 A1
(43) Pub. Date: May 28, 2026

(54) Roadway Obstacle Warning Assembly

(71) Applicant: Thomas Russell, Alpena, MI (US)

(72) Inventor: Thomas Russell, Alpena, MI (US)

(21) Appl. No.: 18/960,731

(22) Filed: Nov. 26, 2024

(51) Int. Cl. G08G 1/16

(52) U.S. Cl. CPC G08G 1/166

(57) ABSTRACT

A roadway obstacle warning assembly for warning oncoming drivers that an object is moving toward a roadway includes a plurality of warning units positioned proximate to the roadway. Each warning unit includes a housing and a processor. A motion sensor is electrically coupled to the processor. The motion sensor detects movement of the object toward the roadway. The processor actuates a plurality of lights when the motion sensor detects movement of the object toward the roadway. The plurality of lights alert the oncoming vehicle that the object is moving toward the roadway. A transceiver is electrically coupled to the processor and is in wireless communication with an adjacent warning unit. The transceiver within a first warning unit signals the processor within the adjacent warning unit to actuate the plurality of lights on the adjacent warning unit when the motion sensor of the first warning unit detects the object.

### (b) CROSS-REFERENCE TO RELATED APPLICATIONS

Not Applicable.

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to traffic control devices and more particularly pertains to a new traffic control device for warning oncoming drivers that an object is approaching a roadway.

### (2) Description of Related Art Including Information Disclosed Under 37 CFR 1.97 and 1.98

The prior art relates to traffic control devices. Traffic control devices are used to provide important information to drivers, such as speed limits, directions, and potential obstacles. For example, street signs are often positioned alongside roadways to provide warnings to drivers of obstacles. For example, some street signs warn drivers that they are entering a school zone, that a cross-walk is ahead, or that wildlife is likely to cross the road in a particular area. However, those street signs only warn drivers of potential obstacles, and do not provide any indication of when an obstacle is actually in, or approaching, the roadway. Because these warning signs always provide the same type of warning, regardless of any actual potential danger from obstacles being in the road, it is easy for drivers to ignore the warnings. Moreover, the signs may be difficult for drivers to see, particularly in heavily wooded areas or areas with low light. Thus, there is a need in the art for a warning system that can alert drivers that obstacles have entered the roadway, or that obstacles are approaching the roadway, in real-time. Ideally, such a warning system would be highly visible, even in heavily obscured areas and low-light conditions.

### (h) BRIEF SUMMARY OF THE INVENTION

An embodiment of the disclosure meets the needs presented above by generally comprising an oncoming vehicle that is being driven along a roadway. A plurality of warning units are positioned proximate to the roadway. Each warning unit of the plurality of warning units includes a housing. A processor is positioned within the housing. A motion sensor is electrically coupled to the processor. The motion sensor is coupled to the housing wherein the motion sensor is configured to detect movement of an object towards the roadway. A plurality of lights are electrically coupled to the processor. The processor is configured to actuate the plurality of lights when the motion sensor detects movement of the object towards the roadway. The plurality of lights are configured to alert a driver of the oncoming vehicle that the object is moving towards the roadway. A transceiver is electrically coupled to the processor. The transceiver is in wireless communication with an adjacent warning unit of the plurality of warning units. The transceiver within a first warning unit is configured to signal the processor within the adjacent warning unit to actuate the plurality of lights on the adjacent warning unit when the motion sensor of the first warning unit detects movement of the object towards the roadway.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a roadway obstacle warning assembly according to an embodiment of the disclosure.

FIG. 2 is a front view of an embodiment of the disclosure.

FIG. 3 is a top view of an embodiment of the disclosure.

FIG. 4 is a bottom view of an embodiment of the disclosure.

FIG. 5 is a block diagram view of an embodiment of the disclosure.

FIG. 6 is an in-use view of an embodiment of the disclosure.

FIG. 7 is a block diagram view of an embodiment of the disclosure.

### (j) DETAILED DESCRIPTION OF THE INVENTION

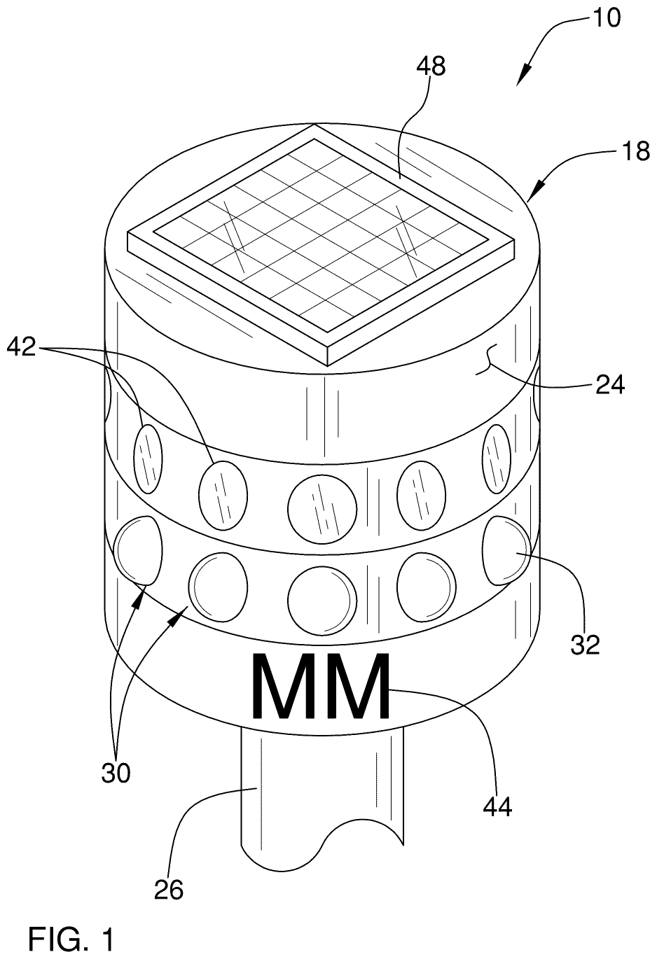

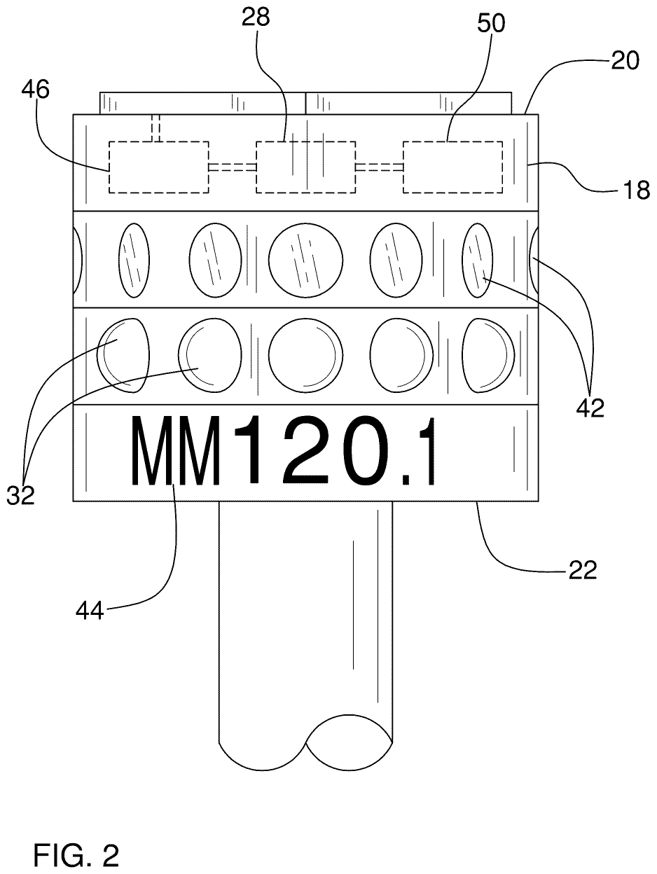

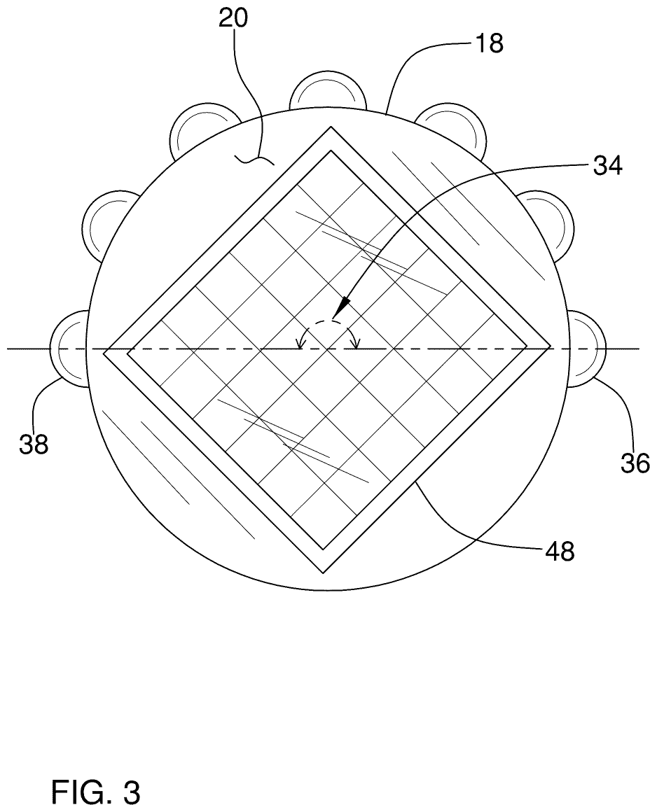

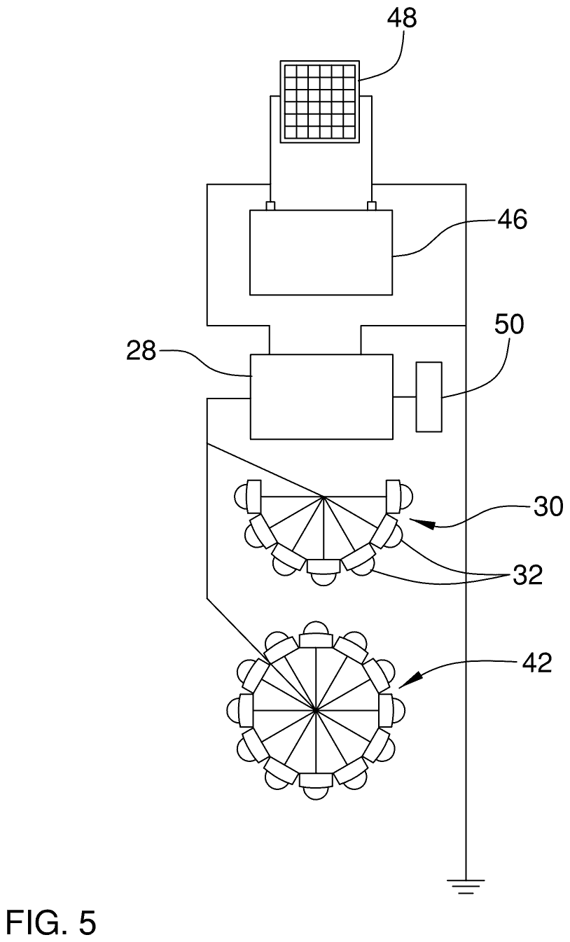

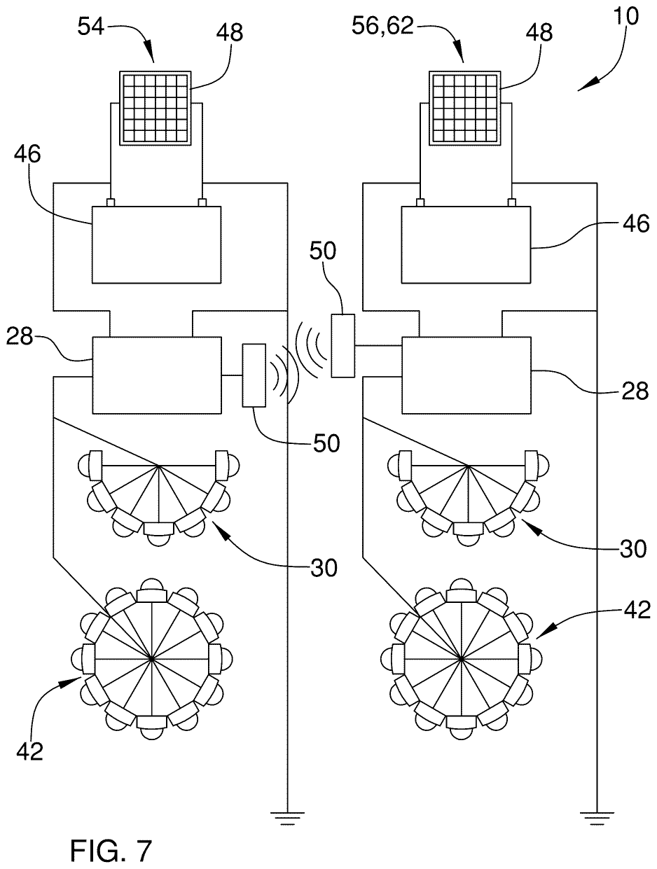

With reference now to the drawings, and in particular to FIGS. 1 through 7 thereof, a new traffic control device embodying the principles and concepts of an embodiment of the disclosure and generally designated by the reference numeral 10 will be described.

As best illustrated in FIGS. 1 through 7, the roadway obstacle warning assembly 10 generally comprises a roadway 12. The roadway generally has a pair of opposing sides 60. An oncoming vehicle 14 is driven along the roadway 12, between the pair of opposing sides 60.

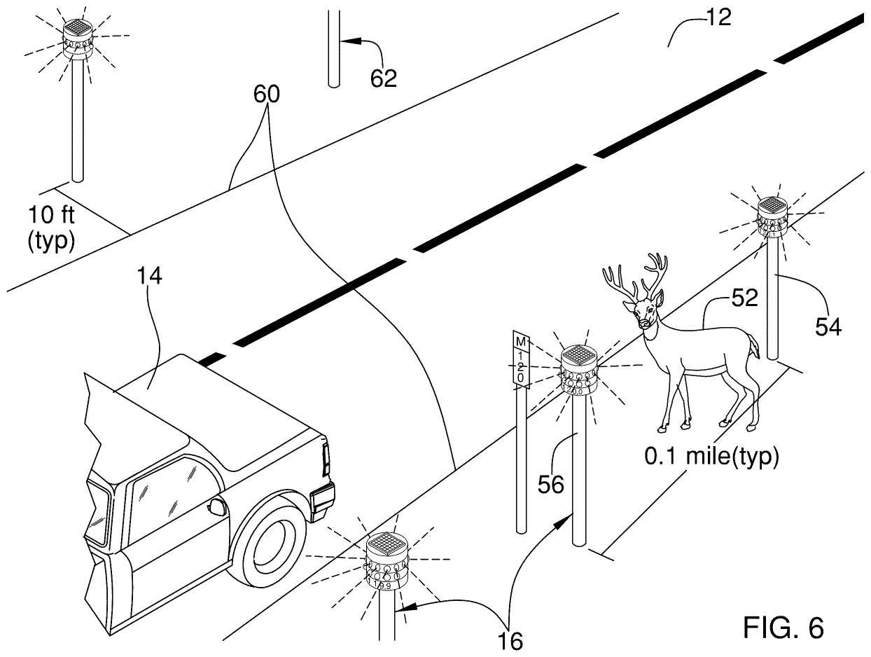

A plurality of warning units 16 are positioned proximate to at least one of the pair of opposing sides 60 of the roadway 12. For example, the plurality of warning units 16 may be spaced from a respective opposing side of the pair of opposing sides 60 of the roadway 12 by a distance being between 5.0 feet and 15.0 feet. In preferred embodiments, the plurality of warning units 16 are positioned along each opposing side of the pair of opposing sides 60 of the roadway 12, as indicated in FIG. 6. The area defined by the distance between the rows of the plurality of warning units 16 across the roadway 12 may be referred to as a “zone” within which the plurality of warning units 16 are configured to detect movement toward the roadway 12, as explained further below. The “zone” generally includes the roadway 12 and the space between each respective opposing side of the roadway 12 and the plurality of warning units 16.

The plurality of warning units 16 are generally spaced from each other along the roadway 12. More specifically, each warning unit of the plurality of warning units 16 is generally aligned with an adjacent warning unit 56 of the plurality of warning units 56 along the respective opposing side of the pair of opposing sides 60 of the roadway 12. The plurality of warning units 16 along the respective opposing side of the pair of opposing sides 60 may be spaced from each other by a distance, measured parallel to the roadway, that is between 0.1 miles and 0.50 miles.

When the plurality of warning units 16 are positioned on both opposing sides of the pair of opposing sides 60 of the roadway 12, the plurality of warning units 16 are also generally aligned with each other across the roadway 12. In other words, each warning unit of the plurality of warning units 16 is generally aligned with an opposing warning unit 62 that is positioned on the opposite side of the pair of opposing sides 60 of the roadway 12.

Each warning unit of the plurality of warning units 16 includes a housing 18. For example, the housing 18 may have a top wall 20, a bottom wall 22, and a side wall 24 that is coupled to and extends between the top wall 20 and the bottom wall 22. The top wall 20 may be planar. The bottom wall 22 may be planar. Each of the top wall 20 and the bottom wall 22 is generally circular wherein the housing 18 is cylindrical.

The housing 18 may have a diameter that is measured across the top wall 20. For example, the diameter may be between 2.0 inches and 5.0 inches. The housing 18 may have a height that is measured between the top wall 20 and the bottom wall 22. For example, the height may be between 3.0 inches and 5.0 inches.

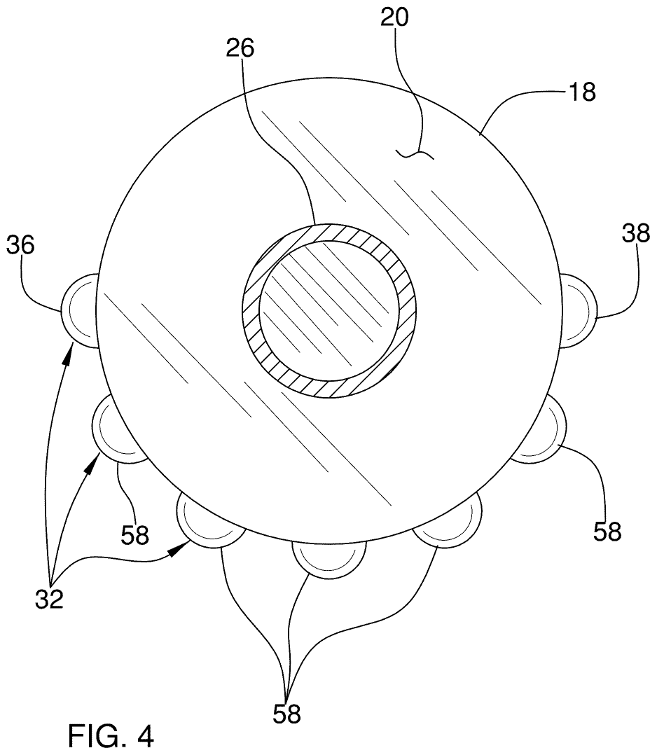

A mount 26 may be coupled to the housing 18. The mount 26 generally supports the housing 18 proximate to the respective opposing side of the pair of opposing sides 60 of the roadway 12. For example, the mount 26 may extend from the bottom wall 22 of the housing 18. The mount 26 may be perpendicular to the bottom wall 22. As shown in FIG. 4, the mount 26 may be centered on the bottom wall 22.

A processor 28 is positioned within the housing 18. A motion sensor 30 is electrically coupled to the processor 28. The motion sensor 30 is generally coupled to the housing 18 wherein the motion sensor 30 is configured to detect movement of an object 52 toward the roadway 12. For example, the motion sensor 30 may detect wildlife, such as the deer shown in FIG. 6, that is moving into the zone and toward the roadway 12. In another example, the object 52 may be another type of animal, such as pets, livestock, or a pedestrian. Other examples of the object 52 are also contemplated.

The motion sensor 30 generally includes a plurality of lenses 32 that are positioned on the side wall 24 of the housing 18. The plurality of lenses 32 may be spaced from each other. The plurality of lenses 32 are generally directed toward the roadway 12 wherein the plurality of lenses 32 detect movement of the object 52 toward the roadway 12. For example, an angle 34 may be formed between a first lens 36 of the plurality of lenses 32 and a final lens 38 of the plurality of lenses 32. The angle 34 may be between 160.0°and 200.0°. The angle 34 may be parallel to the respective opposing side of the roadway 12 wherein the plurality of lenses 32 are configured to detect movement of the object 52 toward and away from the roadway 12.

A plurality of lights 42 are electrically coupled to the processor 28. The processor 28 is generally configured to actuate the plurality of lights 42 when the motion sensor 30 detects movement of the object 52 into the zone and toward the roadway 12. The plurality of lights 42 are configured to alert a driver of the oncoming vehicle 14 that the object 52 is within the zone and moving toward the roadway 12. The processor 28 may also be configured to deactivate the plurality of lights 42 when the motion sensor 30 detects movement of the object 52 out of the zone and away from the roadway 12.

The processor 28 may actuate the plurality of lights 42 to flash at a predetermined rate while the motion sensor 30 detects movement of the object 52 toward the roadway 12. For example, the predetermined rate may be less than 4.0 flashes per second (or 4.0 Hertz) or more than 65.0 flashes per second (or 65.0 Hertz) wherein the predetermined rate is configured to inhibit seizures when the driver has photosensitive epilepsy. Generally, flashing lights that are most likely to trigger seizures are between the frequency of 5.0 and 30.0 flashes per second (or between 5.0 Hertz and 30.0 Hertz), although some people are sensitive to frequencies up to 60.0 flashes per second (or 60.0 Hertz).

The plurality of lights 42 may be positioned on the side wall 24 of the housing 18. For example, the plurality of lights 42 may be positioned between the top wall 20 and the motion sensor 30. The plurality of lights 42 may be spaced from each other. For example, the plurality of lights 42 may be arranged to extend around a circumference of the side wall 24 of the housing 18 wherein the plurality of lights 42 emit light up to 360° around the housing 18.

An indicium 44 may be positioned on the side wall 24 of the housing 18. The indicium 44 may be positioned between the bottom wall 22 of the housing 18 and the motion sensor 30. The indicium 44 generally faces toward the roadway 12 wherein the indicium 44 is configured to be visible to the driver of the oncoming vehicle 14.

The indicium 44 generally includes a number wherein the indicium 44 is configured to represent a mile marker of the roadway 12. For example, the indicium 44 on each warning unit of the plurality of warning units 16 may indicate the mile marker of the roadway 12 up to 1/10^{th} of a mile, as shown in FIG. 6. In such embodiments, the indicium 44 on each warning unit of the plurality of warning units 16 changes by 0.1 mile between adjacent warning units of the plurality of warning units 16. In such embodiments, the plurality of warning units 16 are generally spaced from each other by 0.1 miles along each respective opposing side of the pair of opposing sides 60 of the roadway 12. In another example, the plurality of warning units 16 may be spaced from each other by 0.25 miles along each respective opposing side of the pair of opposing sides 16 of the roadway 12, such that the indicium 44 on each warning unit of the plurality of warning units 16 indicates the mile marker of the roadway 12 in quarter-mile increments. In an emergency, such as an accident, the driver of the oncoming vehicle 14 can view the indicium 44 to provide emergency personnel with a precise location of the emergency, facilitating emergency personnel in responding quickly to the scene.

A power source 46 may be electrically coupled to the processor 28. The power source 46 may be positioned within the housing 18. For example, the power source 46 may be a battery. The battery may be rechargeable. A power generator 48 may be electrically coupled to the power source 46. Specifically, the power generator 48 may be configured to generate power and transfer that power to the power source 46. The power generator 48 may be coupled to the top wall 20 of the housing 18. For example, the power generator 48 may be a solar panel.

A transceiver 50 is electrically coupled to the processor 28. The transceiver 50 is in wireless communication with an adjacent warning unit 56 of the plurality of warning units 16. For example, the transceiver 50 within a first warning unit 54 may be configured to signal the processor 28 within the adjacent warning unit 56 to actuate the plurality of lights 42 on the adjacent warning unit 56 when the motion sensor 30 of the first warning unit 54 detects movement of the object 52 onto the roadway 12. When the motion sensor 30 within the first warning unit 54 detects movement of the object 52 onto the roadway 12, the transceiver 50 may signal the processor 28 of the adjacent warning unit 56, and so on, sending the signal along the roadway 12 toward the oncoming vehicle 14 to provide the driver with a visible indication or warning that the object 52 has been detected on the roadway 12.

In embodiments where the plurality of warning units 16 are positioned on each opposing side of the pair of opposing sides 60 of the roadway 12, the plurality of warning units 16 are generally configured to detect movement of the object 52 toward the roadway 12 from each opposing side of the pair of opposing sides 60 of the roadway 12. In such embodiments, the transceiver 50 of the first warning unit 54 may be in wireless communication with the opposing warning unit 62 on the opposite side of the roadway 12. As explained above, the opposing warning unit 62 is generally aligned with the first warning unit 54 across the roadway 12, as measured perpendicularly to the roadway 12.

The transceiver 50 within the first warning unit 54 may be configured to signal the processor 28 within the opposing warning unit 62 to actuate the plurality of lights 42 on the opposing warning unit 62 when the motion sensor 30 of the first warning unit 54 detects movement of the object 52 into the zone and toward the roadway 12. The plurality of lights 42 on the plurality of warning units 16 on both sides of the roadway 12 would be illuminated. In such embodiments, the plurality of warning units 16 can provide visual warnings of the potential obstacle to drivers who are driving in both directions along the roadway 12, regardless of the side from which the object 52 approaches the roadway 12.

In use, the driver of the oncoming vehicle 14 can check the indicium 44 on each warning unit of the plurality of warning units 16 to determine a precise current location of the oncoming vehicle 14. Specifically, the plurality of warning units 16 can be spaced from each other along the respective opposing side of the pair of opposing sides 60 of the roadway 12 by a distance of between 0.1 miles and 0.5 miles, such that the indicium 44 can provide intermediate measurements for the driver as the oncoming vehicle 14 drives along the roadway 12 between standard mile marker signs.

When the object 52, such as the buck shown in FIG. 6, enters the zone between each row of the plurality of warning units 16 (i.e., moves past the plurality of warning units 16 positioned on one opposing side of the pair of opposing sides 60 of the roadway 12), the motion sensor 30 will detect the movement of the object 52 toward the roadway 12. In other words, as the object 52 moves into the zone by crossing a line defined by the angle 34 between the first lens 36 and the final lens 38 of the plurality of lenses 32 of the motion sensor 30, the motion sensor 30 will detect that movement and signal the processor 28 that the object 52 is moving toward the roadway 12. The motion sensor 30 can differentiate between the object 52 moving towards the roadway 12 and away from the roadway 12 because the plurality of lenses 32 are directed toward the roadway 12, particularly when the line defined by the angle 34 between the first lens 36 and the final lens 38 is parallel to the roadway 12.

For example, when the object 52 moves past either the first lens 36 or the final lens 38, and the intermediate lenses 58 between the first lens 36 and the final lens 38 also detect movement of the object 52, the motion sensor 30 and processor 28 will determine that the object 52 has moved into the zone and is moving toward the roadway 12. Similarly, when the object 52 moves past either the first lens 36 or the final lens 38 and none of the intermediate lenses 58 detect further movement, the motion sensor 30 and the processor 28 will determine that the object 52 has moved out of the zone and is moving away from the roadway 12.

When the object 52 is within the zone, the processor 28 will then actuate the plurality of lights 42 to provide visual indication to the driver of the oncoming vehicle 14 that the object 52 is moving toward the roadway 12, or that the object 52 may be on the roadway 12. The transceiver 50 will send that signal to the adjacent warning unit 56, and along the line of the plurality of warning units 16 toward the oncoming vehicle 14. The transceiver 50 may also send that signal to the opposing warning unit 62, providing visual warnings of the object 52 to drivers on both sides of the roadway 12. The driver of the oncoming vehicle 14 will then have advance notice that the object 52 is within the zone and moving toward the roadway 12, and the driver will have time to slow down, stop, or otherwise respond to the presence of the object 52. Once the object 52 moves away from the roadway 12 and out of the zone, the processor 28 will deactivate the plurality of lights 42. The transceiver 50 can then signal the adjacent warning unit 56, and along the line of the plurality of warning units 16, that the plurality of lights 42 on each of the plurality of warning units 16 can be deactivated. The transceiver 50 may also signal the opposing warning unit 62, turning off the plurality of lights 42 on both sides of the roadway 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A warning system comprising:
an oncoming vehicle being driven along a roadway;
a plurality of warning units being positioned proximate to the roadway, each warning unit of the plurality of warning units including:
a housing;
a processor being positioned within the housing;
a motion sensor being electrically coupled to the processor, the motion sensor being coupled to the housing wherein the motion sensor is configured to detect movement of an object towards the roadway;
a plurality of lights being electrically coupled to the processor wherein the processor is configured to actuate the plurality of lights when the motion sensor detects movement of the object towards the roadway and wherein the plurality of lights are configured to alert a driver of the oncoming vehicle that the object is moving towards the roadway; and
a transceiver being electrically coupled to the processor, the transceiver being in wireless communication with an adjacent warning unit of the plurality of warning units wherein the transceiver within a first warning unit is configured to signal the processor within the adjacent warning unit to actuate the plurality of lights on the adjacent warning unit when the motion sensor of the first warning unit detects movement of the object towards the roadway.

2. The warning system of claim 1, each warning unit of the plurality of warning units further comprising a mount being coupled to the housing wherein the mount supports the housing proximate to the roadway.

3. The warning system of claim 2, wherein the mount extends from a bottom wall of the housing.

4. The warning system of claim 1, the motion sensor of each warning unit of the plurality of warning units further comprising a plurality of lenses being positioned on a side wall of the housing.

5. The warning system of claim 4, wherein the plurality of lenses are directed toward the roadway wherein the plurality of lenses detect movement of the object toward the roadway within an angle being formed between a first lens of the plurality of lenses and a final lens of the plurality of lenses.

6. The warning system of claim 5, wherein the plurality of lights of each warning unit of the plurality of warning units are positioned on the side wall of the housing, the plurality of lights being arranged to extend around a circumference of the side wall.

7. The warning system of claim 1, each warning unit of the plurality of warning units further comprising an indicium being positioned on the side wall of the housing, the indicium including a number wherein the indicium is configured to represent a mile marker of the roadway.

8. The warning system of claim 1, each warning unit of the plurality of warning units further comprising a power source being electrically coupled to the processor.

9. The warning system of claim 8, each warning unit of the plurality of warning units further comprising a power generator being electrically coupled to the power source.

10. The warning system of claim 9, wherein the power generator is a solar panel.

11. The warning system of claim 10, wherein the power generator is coupled to a top wall of the housing.

12. A warning system comprising:
a roadway having a pair of opposing sides;
an oncoming vehicle being driven along the roadway;
a plurality of warning units being positioned proximate to the roadway wherein the plurality of warning units are spaced from a respective opposing side of the pair of opposing sides of the roadway by a distance being between 5.0 feet and 15.0 feet, the plurality of warning units being spaced from each other along the roadway, each warning unit of the plurality of warning units including:
a housing having a top wall, a bottom wall, and a side wall being coupled to and extending between the top wall and the bottom wall, the top wall and the bottom wall being circular wherein the housing is cylindrical;
a mount being coupled to the housing wherein the mount supports the housing proximate to the roadway, the mount extending from the bottom wall;
a processor being positioned within the housing;
a motion sensor being electrically coupled to the processor, the motion sensor being coupled to the housing wherein the motion sensor is configured to detect movement of an object toward the roadway, the motion sensor including:
a plurality of lenses being positioned on the side wall of the housing, the plurality of lenses being spaced from each other wherein the plurality of lenses are configured to detect movement of the object toward the roadway within an angle being formed between a first lens of the plurality of lenses and a final lens of the plurality of lenses, the angle being between 160.0°and 200.0°;
a plurality of lights being electrically coupled to the processor wherein the processor is configured to actuate the plurality of lights when the motion sensor detects movement of the object toward the roadway and wherein the plurality of lights are configured to alert a driver of the oncoming vehicle that the object is moving toward the roadway, the processor being configured to deactivate the plurality of lights when the motion sensor detects movement of the object off away from the roadway, the plurality of lights being positioned on the side wall of the housing between the top wall and the motion sensor, the plurality of lights being arranged to extend around a circumference of the side wall of the housing wherein the plurality of lights are configured to emit light 360°around the housing;
an indicium being positioned on the side wall of the housing, the indicium including a number wherein the indicium is configured to represent a mile marker of the roadway, the indicium being positioned between the bottom wall of the housing and the motion sensor;
a power source being electrically coupled to the processor, the power source being positioned within the housing, the power source being a battery, the battery being rechargeable;
a power generator being electrically coupled to the power source, the power generator being coupled to the top wall of the housing, the power generator being a solar panel;
a transceiver being electrically coupled to the processor, the transceiver being in wireless communication with an adjacent warning unit of the plurality of warning units wherein the transceiver within a first warning unit is configured to signal the processor within the adjacent warning unit to actuate the plurality of lights on the adjacent warning unit when the motion sensor of the first warning unit detects movement of the object onto the roadway;
the plurality of warning units being positioned on each opposing side of a pair of opposing sides of the roadway wherein the plurality of warning units are configured to detect movement of the object toward the roadway from each opposing side of the pair of opposing sides of the roadway, the transceiver of the first warning unit being in wireless communication with an opposing warning unit of the plurality of warning units, the opposing warning unit being aligned with the first warning unit across the roadway, the transceiver within the first warning unit being configured to signal the processor within the opposing warning unit to actuate the plurality of lights on the opposing warning unit when the motion sensor of the first warning unit detects movement of the object toward the roadway.
